(19) United States
(12) Patent Application Publication
(10) Pub. No.: US 2011/0189419 A1
(43) Pub. Date: Aug. 4, 2011

(54) POLYAMIDE, COMPOSITION COMPRISING SUCH A POLYAMIDE AND THEIR USES

(75) Inventors: Guillaume Le, Colombelles (FR); Julien Jouanneau, Pont-Audemer (FR); Thierry Briffaud, Caorches Saint-Nicolas (FR)

(73) Assignee: ARKEMA FRANCE, Colombes (FR)

(21) Appl. No.: 13/002,792

(22) PCT Filed: Jul. 6, 2009
(86) PCT No.: PCT/FR2009/051325

§ 371 Date: Apr. 8, 2011

(30) Foreign Application Priority Data
Jul. 7, 2008 (FR) 0854598

(51) Int. Cl. B32B 1/08; C08G 69/26; C08L 77/06; B32B 1/02

(52) U.S. Cl. 428/36.9; 528/335; 528/339; 528/347; 528/323; 528/326; 528/329.1; 525/432; 524/606; 428/35.7; 428/36.92

(57) ABSTRACT

The invention relates to a polyamide comprising at least two units having the following general formula: 4.Y in which: 4 denotes butanediamine, and Y represents a dicarboxylic acid chosen from a linear or branched aliphatic dicarboxylic acid, a cycloaliphatic diacid and an aromatic diacid, the dicarboxylic acid containing from 7 to 11 carbon atoms, the butanediamine contains carbon of renewable origin, except for the fact that when the polyamide is a copolyamide, it cannot contain 100% by mass of organic carbon derived from renewable raw materials relative to the total mass of polyamide carbon. The invention also relates to a composition comprising this polyamide and the use of this polyamide and of such a composition.

The present invention relates to a polyamide, to the process for preparing same and to the uses thereof, in particular in the manufacture of various objects, for instance common consumer goods such as electrical, electronic or motor vehicle equipment, surgical material, packaging or else sports equipment.

The invention also relates to a composition comprising such a polyamide and also to the uses of this composition in particular in the manufacture of all or part of the objects which have just been listed above.

At the current time, known polyamides exist which are obtained by polycondensation of diamines, such as butanediamine, also known as tetramethylenediamine or alternatively 1,4-diaminobutane, and of diacids. Such polyamides are particularly advantageous since they have many properties such as, for example, very good resistance to high temperatures and a marked crystallinity.

There is an abundant literature on these polyamides, denoted PA 4.Y, irrespective of the nature of the diacid Y, whether it be aliphatic or aromatic. The document High Perform. Polym. 11, (1999), 387-394, Cor Koning and al., relates to PA 4.10 and 4.12 polyamides. It describes the physicochemical characteristics of said polyamides, the method for producing them and their physical and mechanical properties. Patent application EP 0 382 277 describes a polyamide PA 4.6/6 resin composition with improved properties. U.S. Pat. No. 5,084,552 describes a terpolyamide PA 4.6/4T/4I, T denoting terephthalic acid and I denoting isophthalic acid, this terpolymer having improved properties in terms of stability and rigidity. These polyamides obtained from butanediamine are particularly advantageous for the motor vehicle and electrical/electronic fields by virtue of their excellent heat resistance.

However, the environmental concerns of the past few years argue in favor of the development of materials which as must as possible meet the concerns of sustainable development, by limiting in particular the provisioning of starting materials derived from the petroleum industry in their manufacture.

The objective of the present invention is therefore to provide a polyamide having at least some of the properties mentioned above, while at the same time comprising, in its structure, units derived from renewable starting material.

Other characteristics, aspects, subjects and advantages of the present invention will emerge even more clearly on reading the description and the examples which follow.

In general, polyamides comprise at least two identical or distinct repeat units, these units being formed from the two corresponding monomers or comonomers. Polyamides are thus prepared from two or more monomers or comonomers chosen from an amino acid, a lactam and/or a dicarboxylic acid and a diamine.

The objective of the invention is achieved by means of a polyamide comprising at least two units and corresponding to the following general formula:

4.Y

in which 4 denotes butanediamine, and
Y represents a dicarboxylic acid chosen from a linear or branched aliphatic dicarboxylic acid, a cycloaliphatic diacid and an aromatic diacid, the dicarboxylic acid containing from 7 to 11 carbon atoms (limits included),
   characterized in that the butanediamine contains organic carbon of renewable origin, also known as biobased carbon, determined according to standard ASTM D6866.

Thus, the polyamide according to the invention can be a homopolyamide, when it comprises only identical X.Y (4.Y) units. The polyamide according to the invention can also be a copolyamide when it comprises at least two distinct X.Y (4.Y) units. Generally, the copolyamides are denoted X.Y/Z (4.Y/Z), making it possible to distinguish the various comonomers. Preferably, the polyamide according to the invention is a homopolyamide.

A renewable starting material is an animal or vegetable natural resource, the stock of which can be built up again over a short period on the human scale. In particular, it is necessary for this stock to be able to be renewed as quickly as it is consumed.

Generally, the durability of polyamides is one of the essential qualities of these polymers. Polyamides are generally used in applications for which the expected lifetimes are at least of the order of a decade.

When starting materials of renewable origin, such as vegetable oil or sugar cane, for example, are used in the manufacture of these polyamides, it is possible to consider that a certain amount of CO₂ initially withdrawn from the atmosphere during photosynthesis, in the case of plants, is fixed in the material on a long-term basis, thus taking it away from the carbon cycle for at least the entire lifetime of the polyamide product.

In contrast, polyamides of fossil origin do not capture atmospheric CO₂ during their lifetime (for example captured during photosynthesis). They potentially release, at the end of life (for example during incineration), an amount of CO₂ stored in the fossil resource (fossilized carbon) of the order of 2.5 tonnes per tonne of polyamide.

When fossil starting materials are used to manufacture these polyamides, a contribution is thus made, at the end of the life of the material, to reinjecting, into the carbon cycle, carbon which was removed therefrom, since it was fossilized, over a timescale of the order of several million years. In other words, this carbon will be in addition to the cycle, resulting in an imbalance. These phenomena then contribute to the effect of accumulation and thus to the increase in the greenhouse effect.

For the polyamides of the invention, the use of starting materials of renewable origin instead of starting materials of fossil origin contributes to reducing by at least 30% the amounts of fossil CO₂ potentially emitted at the end of life, CO₂ originating from their carbon-based structure.

Unlike the materials resulting from fossil materials, renewable starting materials contain ¹⁴C. All the carbon samples drawn from living organisms (animals or plants) are in fact a mixture of 3 isotopes: ¹²C (representing approximately 98.892%), ¹³C (approximately 1.108%) and ¹⁴C (traces: 1.2×10⁻¹⁰%). The ¹⁴C/¹²C ratio of living tissues is identical to that of the atmosphere. In the environment, ¹⁴C exists in two predominant forms: in the inorganic form, i.e. in the form of carbon dioxide (CO₂), and in the organic form, i.e. in the form of carbon incorporated into organic molecules.

In a living organism, the ¹⁴C/¹²C ratio is kept constant by the metabolism, since the carbon is continually exchanged with the external environment. Since the proportion of ¹⁴C is constant in the atmosphere, the same is true in the organism, while it is living, since it absorbs this ¹⁴C in the same way as the ambient ¹²C. The mean ratio of ¹⁴C/¹²C is equal to 1.2×10⁻¹².

¹²C is stable, i.e. the number of ¹²C atoms in a given sample is constant over time. ¹⁴C is, for its part, radioactive (each gram of carbon of a living being contains sufficient ¹⁴C isotopes to give 13.6 disintegrations per minute) and the number of such atoms in a sample decreases over time (t) according to the law:

n=no exp(−at),

in which:
no is the number of ¹⁴C atoms at the start (at the death of the animal or plant creature),
n is the number of ¹⁴C atoms remaining after time t,
a is the disintegration constant (or radioactive constant); it is related to the half-life.

The half-life (or half-life period) is the time at the end of which any number of radioactive nuclei or unstable particles of a given entity is reduced by half by means of disintegration; the half-life T_{1/2} is related to the disintegration constant a by the formula aT_{1/2}=ln 2. The half-life of ¹⁴C is 5730 years.

Given the half-life (T_{1/2}) of ¹⁴C, the ¹⁴C content is substantially constant from the extraction of the renewable starting materials up to the manufacture of the polyamides according to the invention and even up to the end of their use.

The polyamides according to the invention contain organic carbon (i.e. carbon incorporated into organic molecules) derived from starting materials of renewable origin, which can be certified by determination of the ¹⁴C content according to one of the methods described in standard ASTM D6866-06 (Standard Test Methods for Determining the Biobased Content of Natural Range Materials Using Radiocarbon and Isotope Ratio Mass Spectrometry Analysis). The document is incorporated by way of reference.

This standard ASTM D6866-06 comprises three methods for measuring organic carbon derived from renewable starting materials, known as biobased carbon. The proportions indicated for the polyamides of the invention are preferably measured according to the method by mass spectrometry or the method by liquid scintillation spectrometry which are described in this standard.

Consequently, the presence of ¹⁴C in a material, irrespective of the amount thereof, gives an indication as to the origin of its constituent molecules, namely that they are biobased, i.e. they originate from renewable starting materials and no longer from fossil materials. The measurements carried out by the methods described in standard ASTM D6866-06 thus make it possible to distinguish the starting monomers or starting reactants derived from renewable materials from the monomers or reactants derived from fossil materials. These measurements have a test role.

Thus, by using butanediamine obtained from a renewable starting material, polyamides are obtained which exhibit mechanical, chemical and thermal properties similar to those of the polyamides of the prior art obtained from butanediamine derived from the petrochemical industry, this corresponding at least to one of the sustainable development concerns mentioned above, namely the fact of limiting the use of fossil resources.

In other words, the monomer X of the polyamide is obtained from butanediamine (or 1,4-diaminobutane), which can itself originate entirely from renewable starting materials, identification of which is carried out on the basis of standard ASTM D6866.

The content, expressed as percentage, of renewable or biobased organic carbon in the polyamide according to the invention, denoted % C_{renew.org}, is strictly greater than 0, the content % C_{renew.org} corresponding to the following equation (I):

$$\% {C}_{renew . org} = \frac{{\sum }_{i} Fi \times Ci + {\sum }_{k} Fk \times {Ck}^{′}}{( {\sum }_{j} Fj \times Cj + {\sum }_{i} Fi \times Ci + {\sum }_{k} Fk \times Ck )} \times 100 \qquad ( I )$$

with
i=monomer(s) derived from 100% renewable starting materials,
j=monomer(s) derived from 100% fossil starting materials,
k=monomer(s) derived in part from renewable starting materials,
Fi, Fj, Fk=respective molar fraction(s) of the monomers i, j and k in the polyamide,
Ci, Cj, Ck=respective number (respective mass) of carbon atoms of the monomers i, j and k in the polyamide,
Ck′=number of atoms (respective mass) of renewable or biobased organic carbon in the monomer(s) k,
   the nature (renewable or fossil), i.e. the provenance, of each of the monomers i, j and k being determined according to one of the measuring methods of standard ASTM D6866.

The (co)monomers X and Y are monomers i, j and k within the meaning of the equation (1).

Preferably the polyamide contains a % C_{renew.org} content of greater than or equal to 10%, advantageously greater than or equal to 20%, preferably greater than or equal to 50%.

Otherwise worded, the polyamide comprises at least 10% by mass (or by number of atoms), preferably at least 20% by mass (or by number of atoms), preferably at least 50% by mass (or by number of atoms) of carbon of renewable origin relative to the total mass (or to the total number of atoms) of carbon of the polyamide.

When the polyamide according to the invention has a % C_{renew.org} content of greater than or equal to 25%, a fortiori greater than or equal to 50%, it meets the criteria for obtaining the “Biomass Pla” certification of the JBPA, a certification which is also based on standard ASTM D6866. The polyamide according to the invention can also validly carry the “Biomass-based” label of the organization JORA.

For example, the (co)monomer(s) can be derived from renewable resources, such as vegetable oils or natural polysaccharides, such as starch or cellulose, it being possible for the starch to be extracted, for example, from corn or potato. This or these (co)monomer(s) or starting material(s) can in particular originate from various conversion processes, in particular conventional chemical processes, but also from enzymatic or alternatively biofermentation transformation processes.

When the polyamide is a copolyamide, it cannot contain 100% by mass of organic carbon derived from renewable starting materials relative to the total mass of copolyamide carbon.

For example, the butanediamine can be obtained by amination of succinic acid, itself obtained by enzymatic conversion, in particular the fermentation of sugars or of sugar-containing materials, derived from starch which may be extracted, for example, from wheat, corn, beetroot, potato or sugar cane.

It is also possible to obtain the butanediamine directly by fermentation of a nutritive solution with genetically modified microorganisms. Reference may in particular be made to the teaching of document WO 06/0056034.

According to a first aspect of the invention, the polyamide is a homopolyamide corresponding to the formula 4.Y described above.

More particularly, in the formula 4.Y of the polyamide according to the invention, 4 denotes butanediamine and Y denotes a dicarboxylic acid.

The dicarboxylic acid can be chosen from a linear or branched aliphatic dicarboxylic acid, a cycloaliphatic dicarboxylic acid and an aromatic dicarboxylic acid, the dicarboxylic acid containing from 7 to 11 carbon atoms.

Preferably, when the dicarboxylic acid is a linear aliphatic dicarboxylic acid, it is chosen from heptanedioic acid (y=7), octanedioic acid (y=8), azelaic acid (y=9), sebacic acid (y=10) and undecanedioic acid (y=11).

When the dicarboxylic acid is aromatic, it is preferably chosen from terephthalic acid (denoted T) and isophthalic acid (denoted I).

Among all the possible combinations for the polyamides 4.Y, the polyamides corresponding to one of the formulae chosen from 4.9, 4.10 and 4.T will in particular be retained.

The molar proportions of butanediamine and of diacid are preferably stoichiometric.

The homopolyamide according to the invention can comprise butanediamine monomers originating from renewable resources and, optionally, from fossil resources. Advantageously, the homopolyamide comprises only butanediamine of renewable origin determined according to standard ASTM D6866. In this eventuality, the polyamide has a % C_{renew.org} content that can reach 100%.

The monomer Y (diacid) can originate from fossil resources and/or from renewable resources. In the latter case, the proportion of organic carbon in the final polyamide is increased.

According to a second aspect of the invention, the polyamide is a copolyamide and can comprise at least two distinct units and correspond to the following general formula:

4.Y/Z

in which 4 and Y are as defined above for the homopolyamide,

Z being chosen from a unit obtained from an amino acid, a unit obtained from a lactam and a unit corresponding to the formula (Ca diamine).(Cb diacid), with a representing the number of carbon atoms of the diamine and b representing the number of carbon atoms of the diacid, a and b each being between 4 and 36.

The copolyamide according to the invention can comprise butanediamine monomers, denoted 4, originating from renewable resources and, optionally, from fossil resources. Advantageously, the butanediamine contains only biobased carbon, i.e. carbon of renewable origin determined according to standard ASTM D6866.

When Z represents an amino acid, it may be chosen from 9-aminononanoic acid (Z=9), 10-aminodecanoic acid (Z=10), 12-aminododecanoic acid (Z=12) and 11-aminoundecanoic acid (Z=11) and also its derivatives, in particular N-heptyl-11-aminoundecanoic acid.

In place of one amino acid, a mixture of two, three, or several amino acids could also be envisioned. However, the copolyamides formed would then comprise three, four or more units respectively.

When Z represents a lactam, it can be chosen from pyrrolidinone, piperidinone, caprolactam (Z=6), enantholactam, caprylolactam, pelargolactam, decanolactam, undecanolactam and lauryllactam (Z=12).

Among the combinations that can be envisioned, the following copolyamides are of particularly great interest: they are the copolyamides corresponding to one of the formulae chosen from 4.9/6, 4.9/12, 4.10/6, 4.10/12, 4.2/6 and 4.T/12.

In an advantageous version of the invention, the molar content of Z in the final copolyamide is between 0 (value not included) and 80% (value included), the molar content of butanediamine being between 50% (value not included) and 10% (value included) and the molar content of diacid Y also being between 50% (value not included) and 10% (value included).

When the unit Z is a unit corresponding to the formula (Ca diamine).(Cb diacid), the (Ca diamine) unit is of formula H₂N—(CH₂)—NH₂, when the diamine is aliphatic and linear.

Preferably, the (Ca diamine) monomer is chosen from butanediamine (a=4), pentanediamine (a=5), hexanediamine (a=6), heptanediamine (a=7), octanediamine (a=8), nonanediamine (a=9), decanediamine (a=10), undecanediamine (a=11), dodecanediamine (a=12), tridecanediamine (a=13), tetradecanediamine (a=14), hexadecanediamine (a=16), octadecanediamine (a=18), octadecenediamine (a=18), eicosanediamine (a=20), docosanediamine (a=22) and the diamines obtained from fatty acids.

When the (Ca diamine) monomer is butanediamine, it can be of renewable origin and/or of fossil origin.

When the (Ca diamine) monomer is cycloaliphatic, it is chosen from bis(3,5-dialkyl-4-aminocyclohexyl)methane, bis(3,5-dialkyl-4-aminocyclohexyl)ethane, bis(3,5-dialkyl-4-aminocyclohexyl)propane, bis(3,5-dialkyl-4-aminocyclohexyl)butane, bis(3-methyl-4-aminocyclohexyl)methane (BMACM or MACM), p-bis(aminocyclohexyl)methane (PACM) and isopropylidenedi(cyclohexylamine) (PACP). It can also comprise the following carbon-based backbones: norbornylmethane, cyclohexylmethane, dicyclohexylpropane, di(methylcyclohexyl) or di(methylcyclohexyl)propane. A nonexhaustive list of these cycloaliphatic diamines is given in the publication “Cycloaliphatic Amines” (Encyclopaedia of Chemical Technology, Kirk-Othmer, 4^{th} Edition (1992), pp. 386-405).

When the (Ca diamine) monomer is arylaromatic, it is chosen from 1,3-xylylenediamine and 1,4-xylylenediamine.

When the (Cb diacid) monomer is aliphatic and linear, it is chosen from succinic acid (y=4), pentanedioic acid (y=5), adipic acid (y=6), heptanedioic acid (y=7), octanedioic acid (y=8), azelaic acid (y=9), sebacic acid (y=10), undecanedioic acid (y=11), dodecanedioic acid (y=12), brassylic acid (y=13), tetradecanedioic acid (y=14), hexadecanedioic acid (y=16), octadecanedioic acid (y=18), octadecenedioic acid (y=18), eicosanedioic acid (y=20), docosanedioic acid (y=22) and the dimer fatty acids containing 36 carbons.

The dimer fatty acids mentioned above are dimerized fatty acids obtained by oligomerization or polymerization of unsaturated monobasic fatty acids comprising a long hydrocarbon-based chain (such as linoleic acid and oleic acid), as described in particular in document EP 0 471 566.

When the diacid is cycloaliphatic, it can comprise the following carbon backbones: norbornylmethane, cyclohexylmethane, dicyclohexylmethane, dicyclohexylpropane, di(methylcyclohexyl) or di(methylcyclohexyl)propane.

When the diacid is aromatic, it is chosen from terephthalic acid (denoted T), isophthalic acid (denoted I) and naphthalenedicarboxylic acids.

The specific case where the (Ca diamine).(Cb diacid) unit is strictly identical to the 4.Y unit, the (Ca diamine) monomer being a butanediamine irrespective of whether said butanediamine is of renewable origin and/or of fossil origin, is quite obviously excluded. This is because, in this particular event, a homopolyamide already envisioned according to the first aspect of the invention is concerned.

Among all the possible combinations for the copolyamides 4.Y/Z in which Z is a (Ca diamine).(Cb diacid) unit, the copolyamides corresponding to one of the formulae chosen from 4.9/4.T, 4.9/4.1, 4.10/4.T, 4.10/4.1, 4.9/4.6, 4.10/4.6, 4.9/4.12, 4.10/4.12, 4.T/4.6, 4.T/4.I, 4.T/6.T and 4.T/4.12 will in particular be selected.

The nomenclature used to define the polyamides is described in standard ISO 1874-1:1992 “Plastics—Polyamide (PA) molding and extrusion materials—Part 1: Designation”, in particular on page 3 (tables 1 and 2), and is well known to those skilled in the art.

According to another aspect of the invention, the copolyamide also comprises at least one third unit and corresponds to the following general formula:

4.Y/Z/A

in which

A is chosen from a unit obtained from an amino acid, a unit obtained from a lactam and a unit corresponding to the formula (Cd diamine).(Ce diacid), with d representing the number of carbon atoms of the diamine and e representing the number of carbon atoms of the diacid, d and e each being between 4 and 36.

In the formula 4.Y/Z/A, reference will be made to that which was described above for the (co)monomers or units 4.Y, on the one hand, and Z, on the other hand.

In this same formula, the A unit has the same meaning as the Z unit defined above. The specific case where the A unit is strictly identical to the Z unit is quite obviously excluded.

Among all the possible combinations for the copolyamides 4.Y/Z/A, the copolyamides corresponding to one of the formulae chosen from 4.9/6/4.T, 4.9/6/4.1, 4.10/6/4.T, 4.10/6/4.1, 4.9/6/4.6, 4.10/6/4.6, 4.9/6/4.12, 4.10/6/4.12, 4.9/12/4.T, 4.9/12/4.1, 4.10/12/4.T, 4.10/12/4.1, 4.9/12/4.6, 4.10/12/4.6, 4.9/12/4.12, 4.10/12/4.12, 4.9/11/4.T, 4.9/11/4.1, 4.10/11/4.T, 4.10/11/4.1, 4.9/11/4.6, 4.10/11/4.6, 4.9/11/4.12 and 4.10/11/4.12 will in particular be selected.

The Z and A units can originate from fossil resources and/or be biobased i.e. originate from renewable resources, thus increasing the proportion of organic carbon in the final polyamide.

The invention also relates to a process for preparing a polyamide as defined above, comprising at least one step of polycondensation of butanediamine containing organic carbon of renewable origin, with a dicarboxylic acid, preferably a linear aliphatic dicarboxylic acid or an aromatic dicarboxylic acid, containing 7 to 11 carbon atoms.

The above preparation process can be supplemented, in a first variant, with two steps preceding the abovementioned polycondensation step:

a) isolation of succinic acid from a renewable starting material; optionally, purification,
b) preparation of butanediamine from succinic acid resulting from the preceding step.

According to a second variant, the above preparation process can be supplemented with a step preceding the abovementioned polycondensation step, which consists of the isolation of butanediamine prepared by fermentation in genetically modified microorganisms.

The invention also relates to a composition comprising at least one polyamide according to the invention.

A composition in accordance with the invention can also comprise at least one second polymer.

Advantageously, this second polymer can be chosen from a semicrystalline polyamide, an amorphous polyamide, a semicrystalline copolyamide, an amorphous copolyamide, a polyetheramide, a polyesteramide and blends thereof.

Preferably, this second polymer is obtained from a renewable starting material, i.e. a material corresponding to the test of standard ASTM D6866.

This second polymer can in particular be chosen from starch, which can be modified and/or formulated, cellulose or derivatives thereof such as cellulose acetate or cellulose ethers, polylactic acid, polyglycolic acid and polyhydroxyalkanoates.

The composition according to the invention can also additionally comprise at least one additive.

This additive can in particular be chosen from fillers, fibers, dyes, stabilizers, in particular UV stabilizers, plasticizers, impact modifiers, surfactants, pigments, brighteners, antioxidants, natural waxes, and mixtures thereof.

Among the fillers, mention may in particular be made of silica, carbon black, carbon nanotubes, expanded graphite, titanium oxide or glass beads.

Preferably, this additive will be of natural and renewable origin, i.e. corresponding to the test of standard ASTM D6866.

While, with the exception of N-heptyl-11-aminoundecanoic acid, the dimer fatty acids and the cycloaliphatic diamines, the comonomers or starting products envisioned in the present description (amino acids, diamines, diacids) are actually linear, there is nothing to prevent them being envisioned as possibly totally or partially branched, such as 2-methyl-1,5-diaminopentane, or partially unsaturated.

It will in particular be noted that the Cₙ dicarboxylic acid can be octadecanedioic acid, which is saturated, or else octadecenedioic acid, which, for its part, has an unsaturation.

The polyamide according to the invention or also the composition according to the invention can be used to constitute a structure.

This structure can be a monolayer structure, when it is formed only from the polyamide or only from the composition according to the invention.

This structure can also be a multilayer structure, when it comprises at least two layers and when at least one of the various layers forming the structure is formed from the polyamide or from the composition according to the invention.

The structure, whether monolayer or multilayer, can in particular be in the form of fibers, of a film, of a tube, of a hollow body or of an injected component.

The use of the polyamide or of the composition according to the invention can also be envisioned for all or part of components of electrical and electronic goods, such as telephones, computers or multimedia systems.

The polyamides and compositions of the invention can be manufactured according to the usual processes described in the prior art. Reference will in particular be made to document DE 4318047 or U.S. Pat. No. 6,143,862.

The present invention will now be described in the examples below, such examples being given for illustrative purposes only, and very clearly without implied limitation.

Various homopolyamides and copolyamides were prepared using 2, 3 or 4 monomers according to the specific compositions (Examples A to H) given in the following Table 1.

The monomers used are:
butanediamine derived from a renewable resource, denoted DA4 in the table, CAS 110-60-1,
adipic acid, denoted DC6 in the table, CAS 124-04-9,
azelaic acid derived from a renewable resource, denoted DC9 in the table, CAS 123-99-9,
sebacic acid derived from a renewable resource, denoted DC10 in the table, CAS 111-20-6,
terephthalic acid, denoted T in the table, CAS 100-21-0,
caprolactam, denoted L6 in the table, CAS 105-60-2,
11-aminoundecanoic acid derived from a renewable resource, denoted A11 in the table, CAS 2432-99-7,
lauryllactam, denoted L12 in the table, CAS 947-04-6.

The preparation process, which can be adapted for all of Examples A to H, will now be described in detail for Example A

7.8 g of butanediamine, 17.17 g of sebacic acid and 15 g of water are introduced into a 250 ml autoclave. This mixture is heated with stirring at 160° C. and then the water is gradually eliminated and the temperature increased to 220° C. The polymerization is then carried out under autogenous pressure at 220° C. After this first step, the prepolymer obtained is post-condensed under flushing with nitrogen and steam (10/1) at 220° C. until a polyamide having the desired viscosity is obtained.

TABLE 1

| | | | | | | | | | % (w) |
|---|---|---|---|---|---|---|---|---|---|
| | | | | | | | | | renewable |
| | DA4 | DC6 | DC9 | DC10 | T | L6 | A11 | L12 | C (ASTM |
| Examples | mol % | mol % | mol % | mol % | mol % | mol % | mol % | mol % | D6866) |
| A | 50 | 0 | 0 | 50 | 0 | 0 | 0 | 0 | 100.0 |
| B | 50 | 0 | 50 | 0 | 0 | 0 | 0 | 0 | 100.0 |
| C | 50 | 0 | 0 | 25 | 25 | 0 | 0 | 0 | 69.2 |
| D | 50 | 25 | 0 | 25 | 0 | 0 | 0 | 0 | 75.0 |
| E | 25 | 0 | 0 | 25 | 0 | 50 | 0 | 0 | 53.8 |
| F | 40 | 0 | 0 | 40 | 0 | 0 | 0 | 20 | 70.0 |
| G | 40 | 0 | 0 | 25 | 15 | 0 | 20 | 0 | 84.0 |
| H | 50 | 0 | 0 | 0 | 50 | 0 | 0 | 0 | 33.3 |

2/ Evaluation of the Atmospheric CO₂ Exited from the Carbon Cycle

Table 2 below gives the amounts of atmospheric CO₂ “exited” from the carbon cycle when one tonne of polyamides according to the invention is produced.

TABLE 2

| | 4.9 | 4.10 | 4.T |
|---|---|---|---|
| Atmospheric | 2.73 tonnes | 2.75 tonnes | 0.81 tonnes |
| CO₂ equivalent | | | |
| stored/tonne | | | |
| of PA | | | |

### 3/ Evaluation of the Mass of CO₂ Potentially Released at the End of Life

The measurement is carried out on 4.T having a molecular formula for the repeat unit of C₁₂H₁₄N₂O₂, the molar mass of the repeat unit being 218 g/mol with a mass of carbon C of 144 g/mol, i.e. a total % C=66%.

TABLE 3

| | 4 .T | 4.T |
|---|---|---|
| | 100% derived | partially biobased |
| | from fossil | according to the |
| | resources | invention |
| % renewable C/all | 0 | 33 |
| of the C constituting | | |
| the PA | | |
| Mass of non-neutral CO₂ | 2.42 | 1.61 |
| (t) originating from | | |
| the backbone per tonne | | |
| of PA potentially | | |
| released at the end of | | |
| life (incineration) | | |
| % reduction in fossil | 0 | 33 |
| CO₂ released during | | |
| incineration | | |

1. A polyamide comprising at least two units corresponding to the following general formula:
4.Y
in which:
4 denotes butanediamine, and
Y represents a dicarboxylic acid chosen from a linear or branched aliphatic dicarboxylic acid, a cycloaliphatic diacid and an aromatic diacid, the dicarboxylic acid containing from 7 to 11 carbon atoms,
characterized in that the butanediamine contains organic carbon of renewable origin determined according to standard ASTM D6866,
with the exception of the fact that, when the polyamide is a copolyamide, it cannot contain 100% by mass of organic carbon derived from renewable starting materials relative to the total mass of the polyamide carbon.

2. The polyamide as claimed in claim 1, characterized in that the polyamide contains at least 10% by mass, preferably 20% by mass, preferably 50% by mass of carbon of renewable origin relative to the total mass of the polyamide carbon.

3. The polyamide as claimed in claim 1, characterized in that the diacid Y is
chosen from heptanedioic acid (y=7), octanedioic acid (y=8), azelaic acid (y=9), sebacic acid (y=10), undecanedioic acid (y=11), terephthalic acid (y=T) and isophthalic acid (y=I).

4. The polyamide as claimed in claim 1, characterized in that the polyamide is a homopolyamide.

5. The polyamide as claimed in claim 1, characterized in that the monomer Y contains organic carbon of renewable origin determined according to standard ASTM D6866.

6. The polyamide as claimed in claim 1, characterized in that it is of formula 4.9, 4.10 and 4.T.

7. The polyamide as claimed in claim 1, characterized in that it is a copolyamide comprising at least two distinct units corresponding to the following general formula:
4.Y/Z
in which:
4 and Y are as defined in any one of the preceding claims,
Z is chosen from a unit obtained from an amino acid, a unit obtained from a lactam and a unit corresponding to the formula (Ca diamine).(Cb diacid), with a representing the number of carbons of the diamine and b representing the number of carbons of the diacid, a and b each being between 4 and 36.

8. The polyamide as claimed in claim 7, characterized in that it is a copolyamide chosen from the copolyamides having the following formula: 4.9/4.T, 4.9/4.1, 4.10/4.T, 4.10/4.1, 4.9/4.6, 4.10/4.6, 4.9/4.12, 4.10/4.12, 4.9/6, 4.10/6, 4.9/12, 4.10/4.12, 4.T/4.6, 4.T/4.1, 4.T/6.T and 4.T/4.12.

9. A process for preparing a polyamide as defined in claim 1, comprising at least one step of polycondensation of butanediamine containing carbon of renewable origin determined according to standard ASTM D6866, with a dicarboxylic acid chosen from a linear aliphatic dicarboxylic acid, a cycloaliphatic diacid and an aromatic diacid, the dicarboxylic acid containing from 7 to 11 carbon atoms.

10. A composition comprising at least one polyamide as claimed in claim 1.

11. The composition as claimed in claim 10, characterized in that it also comprises at least one second polymer chosen from a semicrystalline or amorphous polyamide, a semicrystalline or amorphous copolyamide, a polyetheramide, a polyesteramide, and blends thereof.

12. The composition as claimed in claim 10, characterized in that the second polymer is obtained from a renewable starting material determined according to standard ASTM D6866.

13. The composition as claimed in claim 10, characterized in that it also comprises at least one additive, preferably of natural and renewable origin determined according to standard ASTM D6866, this additive being chosen from fillers, fibers, dyes, stabilizers, in particular UV stabilizers, plasticizers, impact modifiers, surfactants, pigments, brighteners, antioxidants, natural waxes, and mixtures thereof.

14. A monolayer structure or at least one layer of a multilayer structure comprising a polyamide according to claim 1.

15. The structure as claimed in claim 14, characterized in that the structure is in the form of fibers, of a film, of a tube, of a hollow body or of an injected component.
